(19) United States
(12) Patent Application Publication
(10) Pub. No.: US 2023/0223729 A1
(43) Pub. Date: Jul. 13, 2023

(54) MODE-LOCKABLE RING OSCILLATOR AND ASSOCIATED METHODS

(71) Applicant: Cornell University, Ithaca, NY (US)

(72) Inventors: Henry HAIG, Ithaca, NY (US); Pavel SIDORENKO, Ithaca, NY (US); Frank WISE, Ithaca, NY (US)

(21) Appl. No.: 18/094,268

(22) Filed: Jan. 6, 2023

Related U.S. Application Data
(60) Provisional application No. 63/266,564, filed on Jan. 7, 2022.

(51) Int. Cl. H01S 3/00; H01S 3/067; H01S 3/10; H01S 3/1112; H01S 3/094

(52) U.S. Cl. CPC H01S 3/0057; H01S 3/06791; H01S 3/06716; H01S 3/10023; H01S 3/1112; H01S 3/094003

(57) ABSTRACT

A mode-lockable ring oscillator includes a gain element for amplifying an optical pulse into an amplified pulse, a nonlinear optical element for broadening the amplified pulse into a first spectrally-broadened pulse, a first optical filter for filtering the first spectrally-broadened pulse into a first filtered pulse, a passive nonlinear optical element for broadening the first filtered pulse into a second spectrally-broadened pulse, and a second optical filter for filtering the second spectrally-broadened pulse into a second filtered pulse. The first and second optical filters have passbands that partially overlap such that the ring cavity can lase CW. With these spectrally overlapping passbands, the mode-lockable ring oscillator can directly initiate single-pulse mode-locking by modulating pump power that pumps the gain element. After this modulation has stopped, the mode-lockable ring oscillator maintains this single-pulse mode-locking while the passbands remain spectrally overlapped.

### RELATED APPLICATIONS

This application claims priority to U.S. Provisional Patent Application No. 63/266,564, filed on Jan. 7, 2022, the entirety of which is incorporated herein by reference.

### STATEMENT REGARDING FEDERALLY SPONSORED RESEARCH OR DEVELOPMENT

This invention was made with government support under Grant No. EB002019 awarded by the National Institutes of Health, Grant No. DE-SC0019546 awarded by the U.S. Department of Energy, and Grant No. ECCS-1912742 awarded by the National Science Foundation. The government has certain rights in the invention.

### BACKGROUND

High-peak-intensity ultrafast fiber lasers can be used in various applications in industry, defense, medicine, and other endeavors. Fiber lasers possess many advantages over their solid-state counterparts including compactness, good thermo-optical properties, and excellent beam quality.

### SUMMARY

A conventional Mamyshev ring oscillator (also referred to as a “Mamyshev pulse generator” in some prior art) uses first and second Mamyshev regenerators that are coupled to each other to create a ring cavity, i.e., the output of the first Mamyshev regenerator feeds the input of the second Mamyshev regenerator and vice versa. Each regenerator includes an amplifier, a non-linear optical element that introduces spectral broadening via self-phase modulation, and a spectral filter. The two spectral filters have passbands that are spectrally offset from each other, thereby implementing an effective saturable absorption mechanism that prefers pulsed operation (i.e., mode-locking) over continuous-wave (CW) operation. An intra-cavity Faraday rotator may be used to ensure that pulses propagate through the ring cavity in only one direction. Light is typically coupled out of the ring cavity at one or both of the two spectral filters.

To initiate mode-locking in many conventional Mamyshev oscillators, the passbands of one or both of the two spectral filters are tuned such that they are partially overlapped. When there is enough spectral overlap, the ring cavity will lase CW. At this point, mode-locking can be initiated via modulation of the pump power that pumps one of the amplifiers. However, the resulting mode-locking is “multi-pulse”, i.e., at any given time there are multiple pulses propagating through the ring cavity. Although multi-pulse mode-locking is useful for some applications, there are many instances where “single-pulse” mode-locking is preferred, i.e., there is only one pulse propagating through the ring cavity at any given time.

To transition the laser from multi-pulse mode-locking to single-pulse mode-locking, one or both of the spectral filters are adjusted to increase the spectral separation between their two passbands. This increase in spectral separation removes any spectral overlap between the two filters. Thus, there is a tradeoff: the partial spectral overlap used to initiate mode-locking via pump modulation prevents single-pulse mode-locking while the lack of spectral overlap used to create single-pulse mode-locking inhibits the initiation of mode-locking. As a result of this trade-off, prior-art Mamyshev oscillators are constructed with tunable spectral filters that increase the system complexity and cost, as compared to the use of fixed spectral filters. Furthermore, since many spectral filters are tunable via mechanical means (e.g., rotation of a grating), tunable spectral filters frequently use mechanical components that increase the sensitivity of the oscillator to external environmental perturbations (e.g., mechanical vibrations and temperature fluctuations).

The present embodiments include mode-lockable ring oscillators that directly transition from CW operation to single-pulse mode-locking using partially-overlapped spectral filters. These mode-lockable ring oscillators are similar to Mamyshev oscillators in that each contains two “arms” that are connected to each other to form a ring cavity. The first arm is a Mamyshev regenerator that includes an amplifier (i.e., a gain stage), a first non-linear optical element, and a first spectral filter. The second arm is similar to a Mamyshev regenerator except that it lacks an amplifier, e.g., it has a passive non-linear optical element and a second spectral filter. For simplicity, this first arm is also referred to as the “active arm” while the second arm is also referred to as the “passive arm”. Since the present embodiments rely on two spectrally-offset filters, they may also be referred to herein as “Mamyshev oscillators”.

The present embodiments not only simplify Mamyshev-oscillator architecture by allowing the use of fixed spectral filters, but they also remove one the two gain stages used in prior-art Mamyshev ring oscillators. This means that the present embodiments can operate with only one pump and one pump coupler (e.g., a wavelength-division multiplexer), which further simplifies construction and increases robustness by reducing component count. With these advantages, the present embodiments include all-fiber Mamyshev ring oscillators in which every component is fiber-optic. In one of these embodiments, all optical fibers are polarization maintaining. All-fiber lasers and oscillators are advantageous (e.g., as compared to their solid-state counterparts) since they are far more robust to environmental perturbations, and therefore can be used for applications outside of research laboratories. However, the present embodiments also include Mamyshev ring oscillators that are partially fiber-optic (i.e., only some of the components are fiber-optic) and free-space (i.e., none of the components are fiber-optic).

In some of the present embodiments, the gain stage of the active arm operates with what is known in the art as the “gain-managed nonlinearity”. In this regime, the gain spectrum of the gain stage (e.g., a doped optical fiber) varies along its length as nonlinear spectral broadening changes how the gain stage is pumped. Advantageously, gain-managed nonlinearity can be used to generate pulses with higher energy and shorter duration (i.e., coherent spectral bandwidth) than other fiber-based amplification regimes (e.g., the self-similar regime). As discussed in more detail below, an experimental demonstration of one of the present embodiments that operates with gain-managed nonlinearity generated 110-nJ pulses that were compressed to 40 fs and 80 nJ with a simple grating pair. To the inventors' knowledge, the resulting peak power of 1.5 MW is twenty times higher than that of all prior-art all-fiber, self-starting lasers.

One aspect of the present embodiments is the realization that the saturable gain of the present embodiments can be controlled via the properties of the passive non-linear optical element in the passive arm. Strong saturable absorption is the mechanism that enables Mamyshev oscillators to mode-lock at all. It is also directly correlated with the pulse energy that can be attained. Saturable absorption is typically quantified by saturation power. In general, a relatively low saturation power gives rise to low-performance multi-pulse states while a relatively high saturation power gives rise to high-performance single-pulse state.

It is known in the prior art that the separation between the two spectral filters directly controls saturation power. Thus, to build a high-performance Mamyshev oscillator with single-pulse states, the spectral filters need to be well-separated (i.e., have no spectral overlap). As described above, this precludes self-starting since the ring cavity is not resonant. Thus, to start a Mamyshev oscillator with pump modulation alone, the two filters are first turned so that their passbands partially overlap each other. In this case, the ring cavity is spectrally transmissive and can lase CW. Thus, in prior-art Mamyshev oscillators, the filter separation is first reduced to initiate mode-locking into multi-pulse states, after which it is increased to transition to single-pulse states. However, the use of a passive arm instead of a second active arm effectively increases the saturation power without having to spectrally separate the filters. As a result, the present embodiments can directly transition from CW operation to single-pulse mode-locking, even when the spectral filters are partially overlapped.

### BRIEF DESCRIPTION OF THE FIGURES

FIG. 1 is a schematic of a mode-lockable ring oscillator, in embodiments.

FIG. 2A is a plot showing the simulated spectrum of a pulse as it propagates through a ring cavity of the mode-lockable ring oscillator of FIG. 1.

FIG. 2B is a plot showing the simulated energy and bandwidth of the pulse as it propagates through the ring cavity of the mode-lockable ring oscillator of FIG. 1.

FIG. 3A shows a compressed pulse measured by frequency-resolved optical gating (FROG).

FIG. 3B shows the measured spectrum of the compressed pulse of FIG. 3A.

FIG. 3C is a plot comparing relative spectral broadening of fractions of pulses coupled into 1 m of HI-1060 optical fiber to simulated propagation of Gaussian pulses of the same energy and initial bandwidth through the same fiber.

FIG. 3D is a measured RF spectrum at the cavity fundamental repetition rate.

FIG. 4A is a plot showing how the spectrum of the pulses varies over sixty hours of continuous operation.

FIG. 4B is a plot showing relative power fluctuations over the sixty hours of continuous operation.

FIG. 5 is a plot illustrating effective saturable absorption of concatenated Mamyshev regenerators.

### DETAILED DESCRIPTION

Demand for robust ultrafast light sources is increasing as medical, industrial, and scientific communities find new applications for femtosecond pulses. These include surgery [1], protein crystallography [2,3], micro-machining [4], and biomedical imaging [5]. Mode-locked fiber lasers are good candidates for these applications for several reasons, including their excellent efficiency and beam quality. All-fiber designs with polarization-maintaining (PM) fiber are especially well-suited for commonplace use because they require no alignment, have small physical dimensions, and are environmentally stable.

High-power fiber-based light sources pose various technical challenges in practical devices. These challenges include, for example, strong nonlinear processes in optical fiber which can frequently limit the pulse energy. One goal of fiber-laser research is to build high-performance lasers that also realize the practical advantages of fiber.

Mamyshev oscillators (MOs) have been identified as candidates to realize high-energy, all-fiber lasers [6-8]. These lasers use an effective saturable absorber that can stabilize highly nonlinear pulse evolutions. Two offset spectral filters in the cavity prevent continuous-wave (CW) lasing but allow pulses that undergo nonlinear spectral broadening between the filters to propagate through the cavity. MOs with large mode-area fiber [9] and photonic crystal fibers [10] achieve pulse energies on the microjoule scale, which is an order-of-magnitude improvement over fiber lasers with other types of saturable absorber. Typically, MOs are environmentally-stable owing to the use of polarization-maintaining (PM) fiber. Fiber-integrated [11-14] and Bragg-grating [15] spectral filters allow construction of all-fiber, compact, and alignment-free MOs.

Various implementations of the Mamyshev mechanism present technical challenges that result in impractical, complex, and costly MOs. Since MO cavities are not resonant, MOs generally do not self-start. A recently-discovered dissipative Faraday instability allows self-starting operation of MOs designed to operate with low (picojoule) pulse energies, usually in the harmonic model-locking regime [16, 17]. Most high-energy MOs require a picosecond or femtosecond seed pulse from an additional oscillator to initiate pulsation, which is undesirable in a practical instrument [9, 10, 13, 14, 18]. Other designs initiate mode-locking by modulation of the pump power, which can be electronically automated for a “push-button” start [12, 19, 20]. However, in previous designs this method requires additional manipulation of the cavity to reach single-pulse states, which diminishes the viability of this approach for applications that require the most robust operation. The Mamyshev mechanism requires the pulse to broaden spectrally between the offset spectral filters. Some MO designs accomplish this in a ring-type cavity with two gain segments and outputs between the filters, which can be inefficient and costly. Linear-type cavities use a single gain segment, but have not been capable of reaching pulse energies near those of ring-type MOs [20]. While some designs achieve self-starting operation, high-performance, or fiber integration, none has all of these features.

The above and other technical issues in other designs based on the Mamyshev mechanism can be a significant barrier to commercial applications of MOs as practical tools. This is reflected in the large gap between the performance of MOs demonstrated in research labs (>100-nJ and <100-fs pulses [9, 10, 14, 21], and the best performance of a self-starting all-fiber laser (15-nJ and 150-fs pulses [9, 22, 23]) reported to date. All-fiber, self-starting designs will likely be necessary to realize the performance advantages of MOs for practical applications [24].

The present embodiments include Mamyshev ring oscillators with several unique features that result in simplicity in the device structure and construction, ease-of-use, and pulse performance from an all-fiber laser. We constructed and tested prototypes as the first experimental demonstration of a ring MO with a passive arm. The all-PM-fiber Mamyshev oscillators can be constructed by tuning the spectral filter parameters during construction to allow the laser to start reliably to single-pulse mode-locked states with pump modulation and no cavity adjustment on each start. The cavity parameters can be optimized to accommodate a gain-managed nonlinear amplification (GMNA) evolution [25], resulting in 110-nJ pulses that compress to 40 fs outside the cavity and reach a peak power over 1.5 MW. This peak power exceeds previously reported high peak-power from an all-fiber, self-starting laser by a factor of twenty [19]. Additionally, the demonstrated laser pulses output from the disclosed all-PM-fiber Mamyshev oscillators are among the highest-energy and shortest-duration pulses that have been obtained from femtosecond all-fiber oscillators [14]. The environmental stability, ease of starting, and performance of our designs make the disclosed Mamyshev ring oscillators well-suited for practical applications.

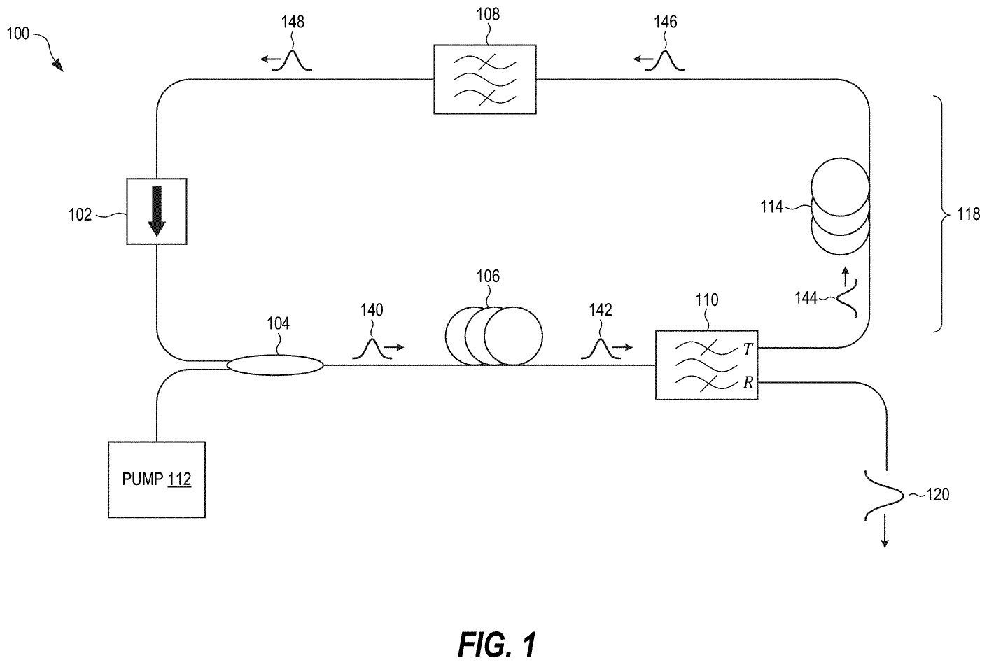

FIG. 1 is a schematic of a mode-lockable ring oscillator 100, in accordance with the present embodiments. The ring oscillator 100 includes several components that are optically coupled to each other to form a ring cavity 118. These components include a gain element 106 that amplifies and spectrally broadens an optical pulse 140 into an amplified pulse. The gain element 106 may also act as a gain-stage nonlinear optical element that uses self-phase modulation to spectrally broaden the amplified pulse into a first spectrally-broadened pulse 142.

In the example of FIG. 1, the gain element 106 is a segment of active fiber doped with one or more laser-active dopants. These dopants are typically the rare-earth elements Yb, Er, Tm, Ho, Pr, and Nd. The active fiber is pumped by a pump laser 112 whose output is coupled into the ring cavity 118 via a combiner 10d4 (e.g., a wavelength-division multiplexer). The active fiber may be single-clad for core pumping or double-clad for cladding pumping. The active fiber may be polarization maintaining. In other embodiments, the gain element 106 is another type of gain medium, such as a solid-state crystal (e.g., Ti:Saph).

The mode-lockable ring oscillator 100 also includes a first optical filter 110 that has a first passband and is coupled to the output of the gain element 106. The first optical filter 110 filter the first spectrally-broadened pulse 142 into a first filtered pulse 144. Specifically, spectral components that pass through the first passband exit the first optical filter 110 via a transmission output port T. These transmitted spectral components form the first filtered pulse 144. Spectral components rejected by the first passband are coupled out of the ring cavity 118 via a rejection output port R. These rejected spectral components form a chirped pulse 120 that may be temporally compressed (e.g., via a prism pair or grating pair) down to femtosecond durations.

The mode-lockable ring oscillator 100 also includes a passive non-linear optical element 114 that is coupled to the transmission output port T to spectrally broaden the first filtered pulse 144 into a second spectrally-broadened pulse 146. In the example of FIG. 1, the non-linear optical element 114 is a segment of passive optical fiber. The passive optical fiber may be polarization-maintaining optical fiber, such as PM-1060 or a similar PANDA-type optical fiber. The passive optical fiber may alternatively be a highly nonlinear optical fiber, such as a large-mode area fiber, a photonic crystal fiber, a microstructured fiber, or a combination thereof In other embodiments, the non-linear optical element 114 is not a fiber-optic element. For example, the non-linear optical element 114 could be a bulk nonlinear crystal (e.g., KTP, BBO, KNbO₃, etc.), a periodically-poled nonlinear crystal (e.g., PPLN), a photonic waveguide, or other type of optical element.

The mode-lockable ring oscillator 100 also includes a second optical filter 108 that has a second passband that partially overlaps the first passband of the first optical filter 110. The second optical filter 108 is coupled to the output of the passive non-linear optical element 114 to filter the second spectrally-broadened pulse 146 into a second filtered pulse 148. In FIG. 1, it is assumed that the optical filters 110 and 108 are bandpass filters. In this case, the first passband has a first center wavelength λ₁ and a first spectral width Δλ₁. Similarly, the second passband has a second center wavelength λ₂ and a second spectral width Δλ₂. Each of the spectra widths Δλ₁ and Δλ₂ may be quantitatively defined as a −3 dB bandwidth (i.e., a full-width at half-maximum), a −20 dB bandwidth, or another type of bandwidth.

The first and second passbands are “partially overlapped” in that there exists (i) a first range of wavelengths that can be transmitted through the first passband but not the second passband, (ii) a second range of wavelengths that can be transmitted through the second passband but not the first passband, and (iii) a third range of wavelengths, located between the first and second ranges, that can be transmitted through both of the passbands. Thus, the first passband cannot completely overlap the second passband and vice versa. The first and second passbands should be sufficiently overlapped such that the peak transmittance in the third range of wavelengths through both of the passbands is high enough that the ring cavity 118 is resonant and therefore capable of lasing CW.

As an example of partially overlapped passbands, consider the case when λ₂<λ₁, i.e., the second passband is shifted to lower wavelengths relative to the first passband. For given values of the spectral widths Δλ₁ and Δλ₂, the second center wavelength λ₂ may be selected such that the lower −3 dB wavelength of the first passband coincides with the upper −3 dB wavelength of the second passband, i.e., λ₂=λ₁−Δλ₁/2−Δ80 ₂/2. In this case, the third range of wavelengths is centered near λ₁+Δλ₁/2=λ₂−λ₂/2, which is the wavelength of peak transmittance. The optical filters 108 and 110 may alternatively be configured with λ₁<λ₂.

The second filtered pulse 148 is coupled back to the input of the gain element 106, thereby completing one loop of the ring cavity 118. As shown in FIG. 1, the mode-lockable ring oscillator 100 may also include an optical isolator 102 to ensure that mode-locked pulses only propagate around the ring cavity 118 in one direction (i.e., counter-clockwise in the example of FIG. 1). In general, optical isolator performance varies with wavelength. Accordingly, it may be advantageous to place the optical isolator 102 in the ring cavity 118 where pulses have the narrowest bandwidth. For this reason, the optical isolator 102 in FIG. 1 is located after the second optical filter 108 and before the gain element 106. However, in principal the optical isolator 102 could be located elsewhere in the ring cavity 118, to the same effect.

In the example of FIG. 1, the gain element 106 both amplifies and spectrally broadens the optical pulse 140. Thus, both amplification and spectral broadening occur simultaneously within a single optical element. In other embodiments, different optical elements are used for this amplification and spectral broadening. For example, the gain element 106 may be a non-broadening gain stage that performs minimal, if any, spectral broadening. This non-broadening gain stage amplifies the optical pulse 140 into an amplified pulse. Following the non-broadening gain stage, a passive non-linear optical element (referred to herein as the “gain-stage non-linear optical element”) spectrally broadens the amplified pulse into the first spectrally-broadened pulse 142. Thus, the ring cavity 118 may be configured with one or more additional passive sources of spectral broadening after amplification without departing from the scope hereof. Examples of this gain stage include, but are not limited to, a fiber amplifier (e.g., an EDFA) and a bulk laser crystal. Examples of the gain-stage non-linear optical element are the same as those described above for the passive non-linear optical element 114.

In some embodiments, all of the components of the mode-lockable ring oscillator 100 are fiber-optic. In particular, the inventors have discovered this all-fiber ring oscillator exhibits excellent long-term stability when all of the fiber-optic components are polarization maintaining. This includes segments of optical fibers (e.g., the gain element 106 and the passive non-linear optical element 114) as well as pigtails used to create fiber-integrated components.

In one prototype example, all passive sections and fiber-integrated components used fiber with a core diameter of 8.5 μm (PM-1060). The gain element 106 in the active arm was a four-meter piece of of co-directionally cladding-pumped active fiber segment (YB1200-10/125DC-PM) with a core diameter of 10 μm. The first optical filter 110 had a 5-nm full-width-at-half-maximum (FWHM) bandwidth centered at 1040 nm. The second optical filter 108 had a 3-nm FWHM bandwidth centered at 1036 nm. Both of the optical filters 110 and 108 had super-Gaussian transmission profiles.

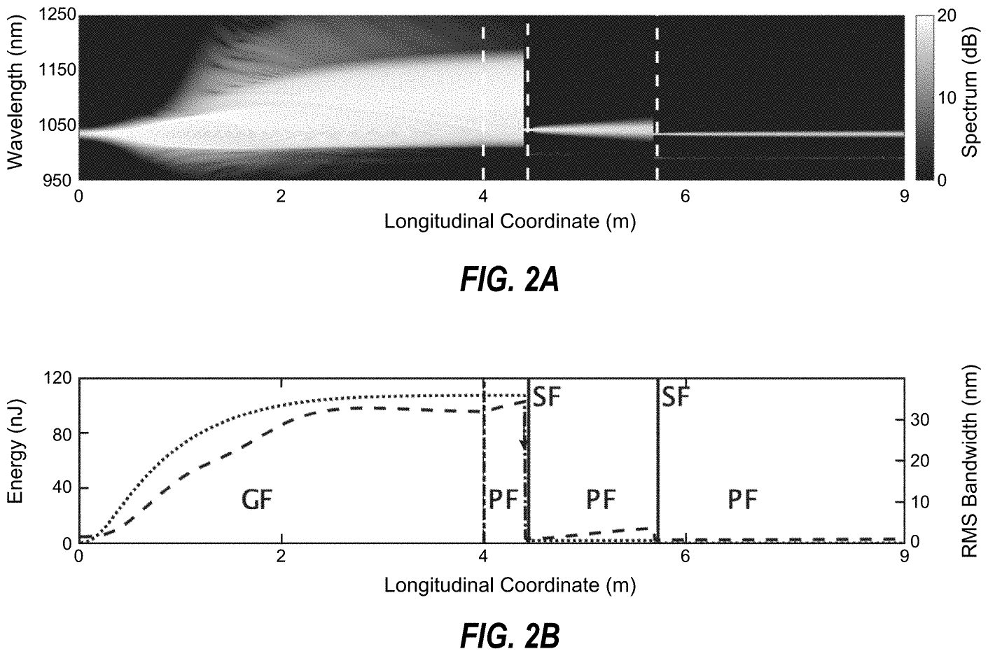

FIG. 2A is a plot showing the simulated spectrum of a pulse as it propagates through the ring cavity 118 of the mode-lockable ring oscillator 100 of FIG. 1. FIG. 2B is a plot showing the simulated energy (dotted line) and bandwidth (dashed line) of the pulse as it propagates through the ring cavity 118. These simulations assume a gain-fiber length of 4 m. In FIGS. 2A and 2B, the x coordinate represents position in the ring cavity 118, as measured from the input of the gain element 106. The first 4 m of the ring cavity 118 was gain fiber (GF) while the rest of the ring cavity 118 was passive fiber (PF). The plots also indicate the locations of the optical filters 110 and 108 (SF).

The plots in FIGS. 2A and 2B were generated from numerical simulations that solved the nonlinear Schrodinger equation [16]. The simulations include Kerr and Raman nonlinearities, self-steepening, and up to fourth-order dispersion. Yb-doped gain media typically have a laser gain profile that is peaked near 1030 nm and has a width of approximately 20 nm. The wavelength of the pump light may be near 976 or 915 nm. The Yb gain spectrum was modeled with steady-state solutions of the rate equations [27, 28]. The model cavity was seeded with a 1-nJ, 1-ps Gaussian pulse with 1040 nm center wavelength which evolves towards a steady-state solution of the cavity over several round trips.

Measurements of the pulse (presented below) agree well with the result of the simulations shown in FIGS. 2A and 2B. In the active arm, the pulse experiences gain and the energy exceeds 100 nJ. The spectrum broadens to well beyond the gain bandwidth of Yb (i.e., the bandwidth of an emission cross-section of the gain element), an indication of evolution in the GMNA regime [25]. In this regime, the gain and pulse spectra co-evolve, and the resulting high-bandwidth pulses are compressible to near the transform limit despite large (e.g., >100π) nonlinear phase accumulation. After amplification, the pulse is spectrally filtered, and several nanojoules pass the filter to propagate through the passive arm. Self-phase modulation (SPM) in the passive optical element 114 causes the spectrum to broaden sufficiently to reach the second optical filter 108 and complete a cavity round-trip.

The particular formats of the fiber-integrated spectral filters used here have significant impact on the starting capability. Center-wavelength separation between the offset spectral filters is a key parameter to control the state and starting dynamics of Mamyshev oscillators [7, 12, 17, 20]. This parameter controls the effective saturable absorption of the Mamyshev mechanism; larger filter separation corresponds to a saturable absorber with greater saturation power [24, 29]. Accordingly, large filter separation yields high-power, single-pulse states, while smaller separation can result in multi-pulsing. However, several studies have observed that to start an MO with pump modulation, the filter separation must be small enough to permit a small CW component prior to pump modulation and mode-locking [12, 20]. This can result in starting to a multi-pulse or low-energy state, where further increase of the spectral filter separation is required to reach a single-pulse state.

In our tested all-PM-fiber Mamyshev oscillators, starting with pump modulation is achieved by control of the spectral filter parameters. The spectral filter following the passive arm has adjustable center-wavelength and bandwidth. While initially constructing the laser, the center wavelength is adjusted to give the maximum separation from the other filter's center (4 nm) that still accommodates a small CW signal. After initial adjustment, these filter settings are not changed. The laser starts with near-perfect reliability to single-pulse states by modulation of the pump power alone. Specifically, we use a simple function generator to create a 70 kHz [20] square wave signal that drives the pump power between 0 and 8 W. Immediately after the modulation starts, a pulse train that is modulated by the pump signal appears on the photodiode trace. When the pump modulation is turned off, the pump power remains at a constant nonzero value and the laser remains mode-locked. The energy of the starting state can be chosen by the value of the steady-state pump power (4-6 W), and can be adjusted after starting without loss of mode-locking or appearance of multi-pulsing. Although we have not performed rigorous starting trials, we succeeded in starting the laser hundreds of times with this method without failure. In addition, we achieved this single-pulse self-starting in many different cavity iterations with different spectral filters, which indicates that these conditions are easily repeatable.

As the pulse energy increases, the spectrum broadens and shifts to longer wavelengths, and the dechirped pulse compresses to shorter durations. This behavior and the broad spectra observed are consistent with those of other MOs and the trends of the GMNA regime [21, 25]. At 110 nJ, a Raman scattering contribution becomes appreciable (˜2% of the pulse energy) above 1150 nm. Increasing the pump power beyond this does not lead to multi-pulsing or loss of mode-locking, even at the highest output powers we observed (3 W). However, above 110 nJ the peak power of the compressed pulse does not increase with pulse energy as the Raman contribution grows.

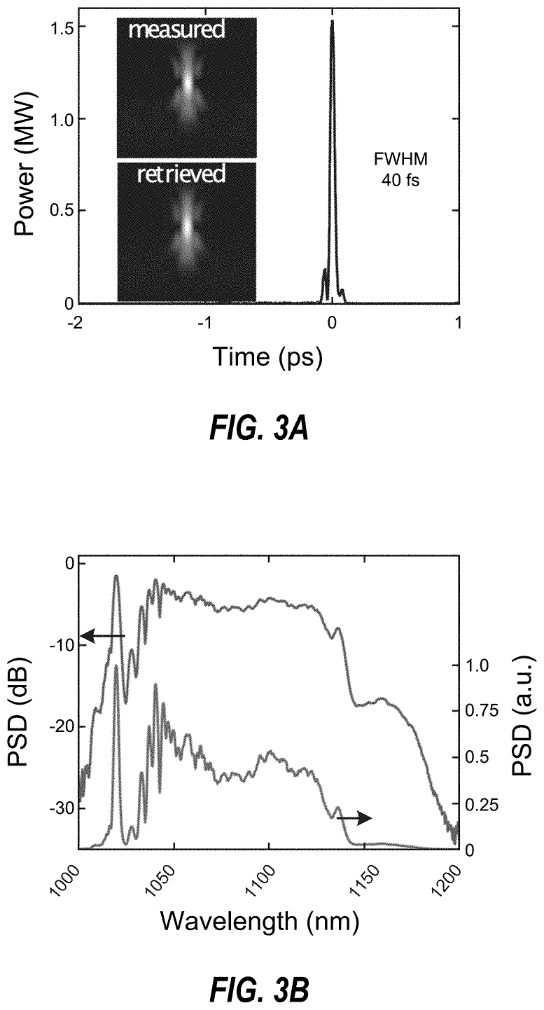

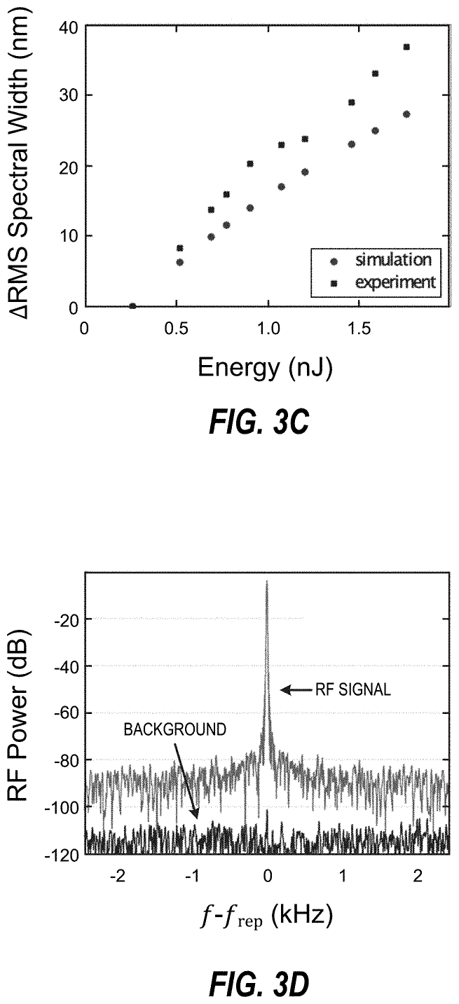

FIGS. 3A-3D summarize a high-performance mode-locked state of an experimental prototype of the mode-lockable ring laser 100 of FIG. 1. Specifically, FIG. 3A shows a compressed pulse measured by frequency-resolved optical gating (FROG). Insets show measured and retrieved FROG traces. FIG. 3B shows the measured spectrum of the compressed pulse of FIG. 3A. Both linear and logarithmic scales are shown. FIG. 3C is a plot comparing relative spectral broadening of fractions of pulses coupled into 1 m of HI-1060 optical fiber to simulate propagation of Gaussian pulses of the same energy and initial bandwidth through the same fiber. FIG. 3D is a measured RF spectrum at the cavity fundamental repetition rate. FIGS. 3A-3D are best viewed together with the following description.

The prototype ring oscillator generated 110-nJ and 4-ps chirped pulses at a 23-MHz repetition rate for an average power of 2.5 W. These are dechirped with a grating pair to yield 80-nJ and 40-fs pulses with an average power of 1.8 W. The peak power is approximately 1.5 MW. The power scale in FIG. 3A was calculated using the energy of the pulse after the compressor. To validate this scale and rule out the presence of either a large pedestal or CW component, we coupled a fraction of the compressed pulse into a single-mode fiber and compared the measured spectral broadening to that of simulated propagation of a Gaussian pulse with the same initial energy and RMS bandwidth (see FIG. 3C). Small discrepancies exist between the simulated and measured bandwidths, but the trend indicates that the power scale in FIG. 3A is valid. The pulse has a small amount of pedestal structure which is estimated to form less than 10% of the pulse energy. Deviation of the pulse from its transform-limited duration of 27 fs is a result of nonlinear phase accumulation and higher-order dispersion during evolution within the cavity. The RF spectrum (see FIG. 3D) indicates stable mode-locking at the fundamental cavity repetition rate, with contrast between the fundamental frequency and secondary modulations of 80 dB.

Both the high pulse energy and the use of a passive arm are enabled in part by using a filter with a rejection port after the active arm. The spectral components that the filter passes remain in the cavity, while the rejected components form the output pulse [8]. Compared to outputting a fraction of the pulse before filtering, this configuration yields the maximum energy for both the output and recirculating pulses. This enables the use of a passive arm: the pulse entering the passive arm has sufficient peak power to spectrally-broaden adequately. Immediately after the filter, the broad output spectrum is near-zero for wavelengths within the filter passband. However, SPM during propagation of the output pulse through a short (20 cm) fiber pigtail regenerates these spectral components. This explains why the measured spectrum shown in FIG. 3B 3 has nonzero amplitude for wavelengths within the spectral filter passband. Notably, neither this output coupling method nor propagation of the pulse through a short fiber pigtail have significant effect on the compressibility of the pulse with a standard grating compressor. Simulations (data not shown) show that the peak power of the compressed output pulse is within 1% of the peak-power of the compressed pulse before output coupling.

The fiber lengths have a significant effect on the output pulse parameters, and are tailored to achieve output pulses with the highest peak power. Specifically, the lengths are chosen to promote evolution in the GMNA regime in the active arm. This requires the use of long gain fiber (4 m) with high gain (>20 dB), and control of the parameters of the pulse that enters the active arm. These parameters are determined primarily by propagation and spectral filtering in the passive arm. The passive arm must be sufficiently long to allow adequate spectral broadening, but we find that using a shortest length (˜1.5 m) that satisfies this requirement produces a pulse with nearly ideal parameters (˜1 nJ, ˜1 ps, Gaussian-like, transform-limited spectrum) to seed the GMNA evolution [25]. Simulations and experiments show that a longer passive arm delivers a pulse to the active arm (i.e., the second filtered pulse 148 in FIG. 1) with additional linear and nonlinear phase structure that results in an amplified pulse of lower quality.

The performance of the laser described here is comparable to the best achieved previously with 10-μm fiber [21]; only a factor of two in peak power has been sacrificed by the all-fiber design and passive arm. It may be possible to exceed the performance described here by well-known techniques, such as the use of larger-core-diameter fiber. This could potentially lead to all-fiber lasers with microjoule-scale pulse energy. However, it is known that the GMNA evolution is ultimately limited by Raman scattering [25] which we also observe here. Design of fiber lasers that exceed the performance limits of the GMNA evolution will require other techniques, or new insight into nonlinear pulse evolutions beyond the GMNA regime.

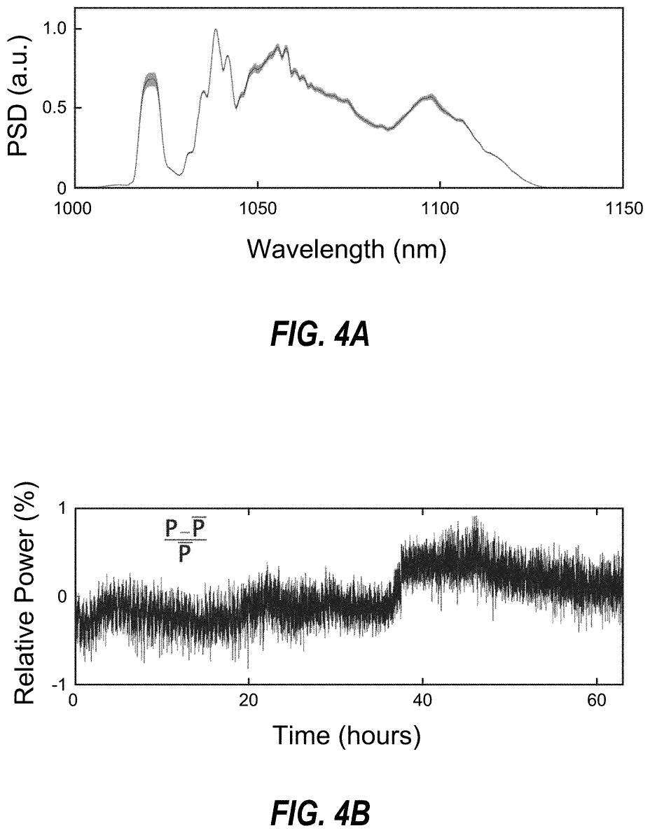

In addition to the excellent pulse parameters and reliable self-starting operation, the prototype ring oscillator provides performance suitable for a practical instrument. For high-power mode-locked states, the efficiency is over 40%: the 2.6 W output power is achieved with 5.7 W of pump power. As expected with the PM fiber design, operation is impervious to mechanical or thermal perturbations. As a longer-term stability test, we recorded the spectrum and average power each minute for 60 hours (see FIGS. 4A and 4B). Over that period, the RMS spectral bandwidth has a standard deviation of 0.25 nm, and the standard deviation of the output power is less than 1 mW (which corresponds to ˜0.5% relative variation). This power fluctuation is within the uncertainty (±3%) of the measurement, and illustrates the excellent stability of the laser. In addition, we never observe spontaneous loss of mode-locking.

FIG. 4A is a plot showing how the spectrum of the pulses varies over sixty hours of continuous operation. Shaded areas show the standard deviation of each spectral component over that timeframe. FIG. 4B is a plot showing relative power fluctuations over the sixty hours of continuous operation.

The small filter separation (4 nm) in this prototype all-PM-fiber Mamyshev oscillator is advantageous because it permits a small CW component and allows self-starting. It is somewhat surprising that our prototype all-PM-fiber Mamyshev oscillator operates in single-pulse states, since previous high-energy Mamyshev oscillators use much larger filter separations (20 nm) [9, 21]. We suspect that the passive arm design may encourage single-pulse operation.

One possible explanation of the above operation is as follows. Considering pulses of the same initial shape and chirp, a Mamyshev regenerator will only pass pulses that have peak power above some threshold. This results in the step-function-like saturable absorber curve of Mamyshev oscillators [24]. Because gain generally enhances spectral broadening, the threshold peak power is greater for a passive Mamyshev regenerator than one with gain. This implies that an oscillator with a passive arm has an effective saturable absorption with higher saturation power than one with two active arms. The use of a passive arm would then have a similar effect on the saturable absorption as increased filter separation. This would enable single-pulse operation even with small filter separation, as we observe. Further work will be necessary to understand how the saturable absorption of Mamyshev oscillators is affected by passive propagation.

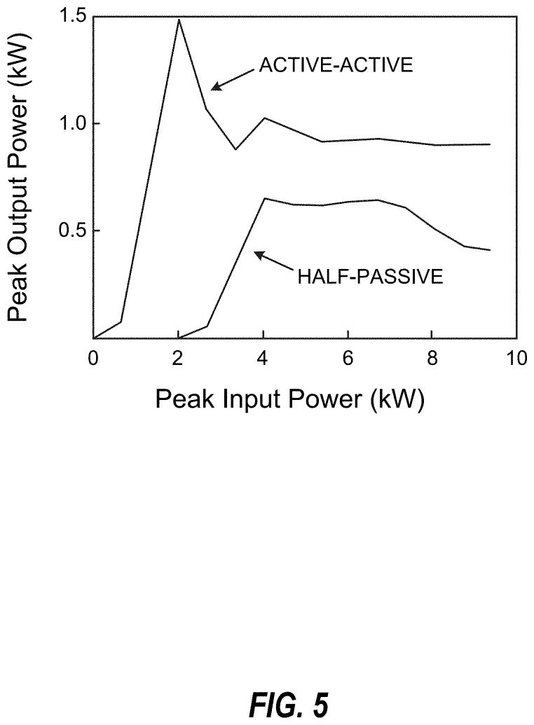

FIG. 5 shows simulations of an effective saturable absorber formed from two different Mamyshev-based configurations: (i) two concatenated Mamyshev regenerators (active-active) and (ii) a Mamyshev regenerator concatenated with a segment of passive optical fiber (half-passive). The transmission characteristic curves in FIG. 5 were generated by simulating the propagation of pulses of fixed duration and bandwidth and varying peak power through each of the two configurations. The data in FIG. 5 indicates the peak power of the output pulse. The “active-active” configuration has a lower saturation power (where the curve sharply increases) than the “half-passive” configuration.

The numerical results shown in FIG. 5 support the conclusion that a passive arm, in lieu of an active arm, promotes single-pulse mode-locking. The saturable absorption curve of an artificial saturable absorber made from concatenated Mamyshev regenerators depends on the spectral filter parameters in addition to the nonlinear media between the filters. FIG. 5 shows higher saturation power (the input power where the transmission sharply increases) for the half-passive configuration of the present embodiments, as compared to the active-active configuration of prior-art Mamyshev oscillators. The fact that higher power is required to increase the transmitted power means that pulses will be stable at higher power. In addition, the transmitted power does not decrease quickly with increasing power, which is the case for the active-active configuration.

### REFERENCES

1. J. D. Steinmeyer, C. L. Gilleland, C. Pardo-Martin, M. Angel, C. B. Rohde, M. A. Scott, and M. F. Yanik, “Construction of a femtosecond laser microsurgery system,” Nat. Protoc. 5, 395 (2010).
2. L. M. Haupert and G. J. Simpson, “Screening of protein crystallization trials by second order nonlinear optical imaging of chiral crystals (sonicc),” Methods 55, 379 (2011).
3. H.-Y. Chung, R. Schubert, S.-H. Chia, S. Falke, C. N. Mudogo, F. X. Kärtner, G. Chang, and C. Betzel, “Protein-crystal detection with a compact multimodal multiphoton microscope,” Commun. Biol. 3, 569 (2020).
4. R. R. Gattass and E. Mazur, “Femtosecond laser micromachining in transparent materials,” Nat. Photonics 2, 219 (2008).
5. C. Xu and F. Wise, “Recent advances in fibre lasers for nonlinear microscopy,” Nat. Photonics 7, 875 (2013).
6. M. Piche, Mode Locking through Nonlinear Frequency Broadening and Spectral Filtering (SPIE, 1994).
7. K. Sun, M. Rochette, and L. R. Chen, “Output characterization of a self-pulsating and aperiodic optical fiber source based on cascaded regeneration,” Opt. Express 17, 10419 (2009).
8. K. Regelskis, J. Želudevičius, K. Viskontas, and G. Račiukaitis, “Ytterbium-doped fiber ultrashort pulse generator based on self-phase modulation and alternating spectral filtering,” Opt. Lett. 40, 5255 (2015).
9. D. Lin, D. Xu, J. He, Y. Feng, Z. Ren, and D. J. Richardson, “Generation of ˜625 nj Pulses from a Mamyshev oscillator with a few-mode LMA Yb-doped Fiber,” in 2021 Conference on Lasers and Electro-Optics Europe & European Quantum Electronics Conference (Optical Society of America, 2021).
10. W. Liu, R. Liao, J. Zhao, J. Cui, Y. Song, C. Wang, and M. Hu, “Femtosecond Mamyshev oscillator with 10-MW-level peak power,” Optica 6, 194 (2019).
11. E. Poeydebat, F. Scol, O. Vanvincq, G. Bouwmans, and E. Hugonnot, “All-fiber Mamyshev oscillator with high average power and harmonic mode-locking,” Opt. Lett. 45, 1395 (2020).
12. E. Poeydebat, F. Scol, O. Vanvincq, G. Bouwmans, and E. Hugonnot, “Pulse energy enhancement via filter shape optimization in an all-fiber Mamyshev oscillator,” Conference on Lasers and Electro-Optics, (Optical Society of America, 2021), paper JTh3A.97.
13. B. Piechal, J. Szczepanek, T. M. Kardaś, and Y. Stepanenko, “Mamyshev oscillator with a widely tunable repetition rate,” J. Lightwave Technol. 39, 574 (2021).
14. T. Wang, B. Ren, C. Li, J. Wu, R. Su, P. Ma, Z.-C. Luo, and P. Zhou, “Over 80 nJ Sub-100 fs All-Fiber Mamyshev Oscillator,” IEEE J. Sel. Top. Quantum Electron. 27, 8800105 (2021).
15. V. Boulanger, M. Olivier, F. Trépanier, M. Bernier, and M. Piché, “Efficient all-PM-fiber Mamyshev oscillator based on fiber Bragg gratings,” in Laser Congress 2020 (ASSL, LAC), (Optical Society of America, 2020), paper JTu5A.6.
16. N. Tarasov, A. M. Perego, D. V. Churkin, K. Staliunas, and S. K. Turitsyn, “Mode-locking via dissipative Faraday instability,” Nat. Commun. 7, 12441 (2016).
17. A. M. Perego, “High-repetition-rate, multi-pulse all-normal-dispersion fiber laser,” Opt. Lett. 42, 3574 (2017).
18. Z. Liu, Z. M. Ziegler, L. G. Wright, and F. W. Wise, “Megawatt peak power from a Mamyshev oscillator,” Optica 4, 649 (2017).
19. I. Samartsev, A. Bordenyuk, and V. Gapontsev, “Environmentally stable seed source for high power ultrafast laser,” in Components and Packaging for Laser Systems III, Proc. SPIE 10085, 100850S (2017).
20. Y.-H. Chen, P. Sidorenko, R. Thorne, and F. Wise, “Starting dynamics of a linear-cavity femtosecond Mamyshev oscillator,” J. Opt. Soc. Am. B 38, 743 (2021).
21. P. Sidorenko, W. Fu, L. G. Wright, M. Olivier, and F. W. Wise, “Self-seeded, multi-megawatt, Mamyshev oscillator,” Opt. Lett. 43, 2672 (2018).

### 22. M. Pielach, B. Piechal, J. Szczepanek, P. Kabaciński, and Y. Stepanenko, “Energy Scaling of an Ultrafast All-PM-Fiber Laser Oscillator,” IEEE Access 8, 145087 (2020).

23. C. Aguergaray, N. G. R. Broderick, M. Erkintalo, J. S. Y. Chen, and V. Kruglov, “Mode-locked femtosecond all-normal all-PM Yb-doped fiber laser using a nonlinear amplifying loop mirror,” Opt. Express 20, 10545 (2012).
24. S. Pitois, C. Finot, L. Provost, and D. J. Richardson, “Generation of localized pulses from incoherent wave in optical fiber lines made of concatenated Mamyshev regenerators,” J. Opt. Soc. Am. B 25, 1537 (2008).
25. P. Sidorenko, W. Fu, and F. Wise, “Nonlinear ultrafast fiber amplifiers beyond the gain-narrowing limit,” Optica 6, 1328 (2019).

### 26. G. P. Agrawal, Nonlinear Fiber Optics, 2^{nd} ed. (Academic Press, 1995).

27. S. K. Turitsyn, A. E. Bednyakova, M. P. Fedoruk, A. I. Latkin, A. A. Fotiadi, A. S. Kurkov, and E. Sholokhov, “Modeling of CW Yb-doped fiber lasers with highly nonlinear cavity dynamics,” Opt. Express 19, 8394 (2011).
28. R. Paschotta, J. Nilsson, A. Tropper, and D. Hanna, “Ytterbium-doped fiber amplifiers,” IEEE J. Quantum Electron. 33, 1049 (1997).
29. J. Želudevičius, M. Mickus, and K. Regelskis, “Investigation of different configurations and operation regimes of fiber pulse generators based on nonlinear spectral re-shaping,” Opt. Express 26, 27247 (2018).

What is claimed is:

1. A method for single-pulse mode-locking, the method occurring within a ring oscillator and comprising:
amplifying, with a gain element of the ring oscillator, an optical pulse into an amplified pulse;
spectrally broadening the amplified pulse into a first spectrally-broadened pulse;
filtering, with a first passband, the first spectrally-broadened pulse into a first filtered pulse with a first passband;
spectrally broadening the first filtered pulse into a second spectrally-broadened pulse;
filtering, with a second passband that partially overlaps the first passband, the second spectrally-broadened pulse into a second filtered pulse; and
coupling the second filtered pulse into an input of the gain element;
wherein there is only one laser pulse propagating within a ring cavity of the ring oscillator at any time.

2. The method of claim 1, a spectrum of the first spectrally-broadened pulse exceeding a bandwidth of an emission cross-section of the gain element.

3. The method of claim 1, wherein said spectrally broadening and said amplifying occur simultaneously within the gain element.

4. The method of claim 3, the gain element comprising a doped optical fiber.

5. The method of claim 1, wherein said amplifying includes amplifying with gain-managed nonlinearity.

6. The method of claim 1, wherein said spectrally broadening the first filtered pulse includes spectrally broadening the first filtered pulse with a passive optical fiber.

7. The method of claim 1, further comprising:
coupling spectral components rejected by the first filter out of the ring cavity, the rejected spectral components forming a chirped pulse; and
temporally compressing the chirped pulse to form an output pulse.

8. The method of claim 7, one or both of:
a peak power of the output pulse being between 0.1 and 10 MW; and
an energy of the output pulse being between 100 and 1000 nJ.

9. A mode-lockable ring oscillator comprising:
a gain element that, when optically pumped, amplifies an optical pulse into an amplified pulse;
a gain-stage nonlinear optical element configured to spectrally broaden the amplified pulse into a first spectrally-broadened pulse;
a first optical filter coupled to an output of the gain-stage nonlinear optical element, the first optical filter being configured to spectrally filter the first spectrally-broadened pulse into a first filtered pulse, the first optical filter having a first passband;
a passive nonlinear optical element coupled to an output of the first optical filter, the passive nonlinear optical element being configured to spectrally broaden the first filtered pulse into a second spectrally-broadened pulse; and
a second optical filter coupled to an output of the passive nonlinear optical element, the second optical filter being configured to filter the second spectrally-broadened pulse into a second filtered pulse, the second optical filter having a second passband that partially overlaps the first passband;
wherein (i) an output of the second optical filter is coupled to an input of the gain element such that the gain element, gain-stage nonlinear optical element, first filter, passive nonlinear optical element, and second filter form a ring cavity and (ii) the mode-lockable ring oscillator is configured to initiate single-pulse mode-locking.

10. The mode-lockable ring oscillator of claim 9, the gain-stage nonlinear optical element being configured such that a spectrum of the first spectrally-broadened pulse exceeds a bandwidth of an emission cross-section of the gain element.

11. The mode-lockable ring oscillator of claim 9, the gain element and the gain-stage nonlinear optical element comprising the same optical element.

12. The mode-lockable ring oscillator of claim 11, the same optical element comprising a doped optical fiber.

13. The mode-lockable ring oscillator of claim 12, the doped optical fiber being polarization-maintaining.

14. The mode-lockable ring oscillator of claim 12, the doped optical fiber comprising a large-mode-area optical fiber, a photonic-crystal fiber, or a microstructure fiber, or a combination thereof.

15. The mode-lockable ring oscillator of claim 9, configured to amplify the optical pulse in the gain element with gain-managed nonlinearity.

16. The mode-lockable ring oscillator of claim 9, the passive nonlinear optical element comprising a passive optical fiber.

17. The mode-lockable ring oscillator of claim 16, the passive optical fiber being polarization-maintaining.

18. The mode-lockable ring oscillator of claim 9, the first filter comprising a rejection port from which spectral components rejected by the first filter are coupled out of the ring cavity.

19. The mode-lockable ring oscillator of claim 12, consisting of only polarization-maintaining fiber-optic-based components.

20. A method comprising:
pumping the gain element of the mode-lockable ring oscillator of claim 9 with pump light;
modulating the pump light during said pumping to initiate single-pulse mode-locking of the mode-lockable ring oscillator, wherein the second passband of the second optical filter partially overlaps the first passband of the first filter when the single-pulse mode-locking is initiated; and
stopping said modulating after the mode-lockable ring oscillator has initiated single-pulse mode-locking.
